(19) United States
(12) Patent Application Publication
(10) Pub. No.: US 2021/0354497 A1
(43) Pub. Date: Nov. 18, 2021

(54) OFFICE CLIP

(71) Applicant: Masaaki AOTO, Osaka (JP)

(72) Inventor: Masaaki AOTO, Osaka (JP)

(21) Appl. No.: 15/930,993

(22) Filed: May 13, 2020

(51) Int. Cl. B42F 1/08

(52) U.S. Cl. CPC B42F 1/08

(57) ABSTRACT

The present invention provides an office clip having a high designability while having a sufficient gripping force. It is an office clip for pinching and binding paper, wherein a ring portion of elastic wire is spirally wound closely or at a predetermined pitch, with at least one end wire of the ring portion being extended inward with respect to the center of the spiral axis, and the end wire being bent toward the direction of the other end of the ring portion, heightening the clamping force and enhancing the designability by one motif created by the end wire.

### TECHNICAL FIELD

This invention relates to an office clip for pinching and binding one or more memo pads and the like.

### BACKGROUND ART

Conventionally, office clips have been widely used to improve the efficiency of office work such as collecting and classifying documents. Although various types of clips for office use have been provided, the actual situation is that they are not so high in terms of designability. Therefore, a clip decorative seal that can be attached to an existing gem clip is known (refer to Patent literature 1). This is because the seal base material is folded in two along the center line and attached, and has the advantage that it does not fall off accidentally.

However, the clip decorative seal disclosed in the above-mentioned Patent Document 1 is not a type of clip decorative seal that gives designability by devising the shape of the clip itself.

A ring-shaped clip in which the clip is ring-shaped is known as a device in which the shape of the clip itself is devised (refer to Patent literature 2). Generally, most of the ring-shaped clips do not have sufficient gripping force between the wire rods, and conversely, if the wire rods are brought into close contact with each other so as to increase the gripping force, there is a problem that it becomes difficult to pinch a document or the like. The ring-shaped clip disclosed in the above-mentioned Patent Document 2 is to insert an insert piece formed so that the end portion is opened in the gap of the ring of the coil-shaped ring, and according to this, a document or the like can be easily sandwiched.

However, although the ring-shaped clip disclosed in Patent Document 2 is highly convenient, it is hard to say that the designability is high.

### PRIOR ART

### Patent Literature

[Patent literature 1] JP 3164960 U
[Patent literature 2] JP 2001-322384 A

### OUTLINE OF THE INVENTION

### Problems to be Solved by the Invention

In view of such a circumstance, the present invention aims to provide an office clip having a high designability while having a sufficient gripping force.

### Means to Solve the Objects

In the aim to solve the above mentioned problems, an office clip of the present invention is an office clip for pinching and binding paper, wherein a ring portion includes elastic wire spirally wound closely or at a predetermined pitch, with at least one end wire of the ring portion being extended inwardly with respect to a center of a spiral, and an end wire bent toward the direction of the other end of the ring portion, thereby heightening the clamping force and enhancing the designability by one motif created by the end wire.

In this way, the end wire is not only extended inward, but is also bent in two steps, such as being bent in a spiral axial direction and in the direction of the other end of the ring part. As a result, a sufficient clamping force can be obtained.

When the elastic wire is wound closely in a spiral shape, there is an advantage that a sufficient holding force can be obtained even when a thin memo paper or the like is held due to the initial tension of the contact winding spring. Here, the initial tension of the closely-wound spring refers to a force that works to bond the wires to each other in the coil portion of the spring, wherein the coil is wound in close contact, even in the unloaded state. As used here two sections of wire are in “close contact” when they have surfaces which are within one wire diameter of each other, for whichever wire section diameter is larger.

Further, the ring portion may have a structure in which an elastic wire is spirally wound at a predetermined pitch. For example, in the case of having a purpose of sandwiching thick paper or the like, it is possible to sandwich the paper even if the pitch is provided, and by providing the pitch, there is an advantage that the paper can be easily inserted.

The elastic wire is preferably made of metal such as iron or steel from the viewpoint of strength, but may be made of resin depending on the cost and use. Further, the ring portion is not limited to a circular shape in planar view, and may be an elliptical shape, a rectangular shape, or other polygonal shapes.

In the present invention, the motif to be produced may be produced only by the end wire or may be produced as one motif by combining the end wire and the ring part.

The office clip of the present invention may be one in which both end wire members are united to create one motif. By combining both end wire rods to create a single motif, it is possible to create a design with higher designability.

In an office clip of the present invention, it is preferable that the motif produced by the end wire is at least one of letters, numbers, or figures.

Here, the characters widely include symbols for transmitting words, and examples thereof include hiragana, katakana, kanji, or Latin characters, but are not limited to these, for example, and Arabic characters, Cyrillic characters, or even an emoji or emoticon may be included.

Also, the number includes a wide range of symbols for expressing numbers, and examples thereof include Arabic numbers and Roman numbers, but the number is not limited to these and Indian numbers or Greek numbers, for example may be included.

The figure includes a wide range of representations of various shapes, and is not limited to a geometrical shape using a circle, a polygon, or the like, and includes, for example, a logo mark indicating a company or an organization.

Also, the shape may be a combination of any of letters, numbers, or figures, such as a combination of characters and letters, letters and numbers, or numbers and figures.

In an office clip of the present invention, a circumferential length of the spiral ring portion is preferably 1.67 or more turns of the spiral. When the circumferential length of the spiral ring portion is less than 1.67 turns of the spiral, the holding portion of the ring portion, that is to say, the portion for holding the memo paper or the like becomes less than 0.67 turns of the spiral, and a sufficient holding force would not be obtained. Therefore, by setting the circumferential length of the spiral ring part to 1.67 or more turns of the spiral, the holding part can be set to 0.67 turns or more of the spiral, and sufficient holding force can accordingly be obtained even when holding a memo paper or the like.

### Effects of the Invention

According to an office clip of the present invention, there is an effect that the office clip here can be used as a highly designed clip while having a sufficient gripping force.

### BRIEF DESCRIPTION OF THE DRAWINGS

FIG. 1 is an external view (1) of an office clip of Embodiment 1.

FIG. 2 is an external view (2) of an office clip of Embodiment 1.

FIG. 3 is an explanatory drawing of an office clip of the present invention.

FIG. 4 is an explanatory view showing a usage state of the office clip of Embodiment 1.

FIG. 5 is an external view of an office clip of Embodiment 2.

FIG. 6 is an explanatory diagram illustrating a usage state of the office clip of Embodiment 2.

FIG. 7 is an external view of an office clip of Embodiment 3.

### BEST MODE FOR CARRYING OUT THE INVENTION

Embodiments of the present invention will be described in detail below with reference to the drawings. The present invention is not limited to the following embodiments and examples shown in the figures, and the present invention can be variously changed in design.

### Embodiment 1

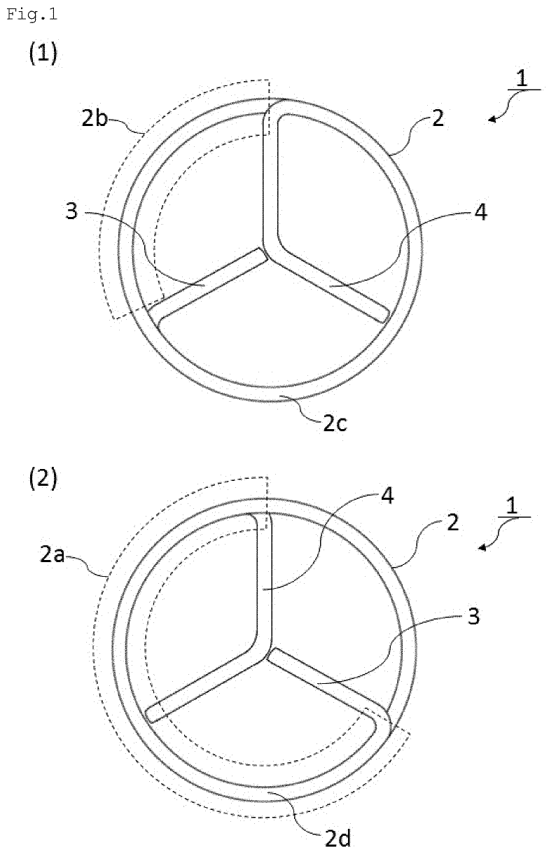

FIG. 1 is an external view of an office clip of Embodiment 1, (1) showing a front view and (2) showing a rear view. As shown in FIG. 1 (1), the office clip 1 is formed by processing one metal wire rod, and the office clip includes a ring portion 2 and end wire rods (3, 4).

Specifically, as shown in FIGS. 1 (1) and (2), in the ring portion 2, the wire rods are spirally wound in a close manner, and the wire rods are formed with a sandwiching portion 2a where the wire rods come into contact with each other and a non-holding portion 2b where the wire rods do not contact each other. The spirally wound length is about one round and two thirds of the spiral, where “about” means within one-tenth of a round.

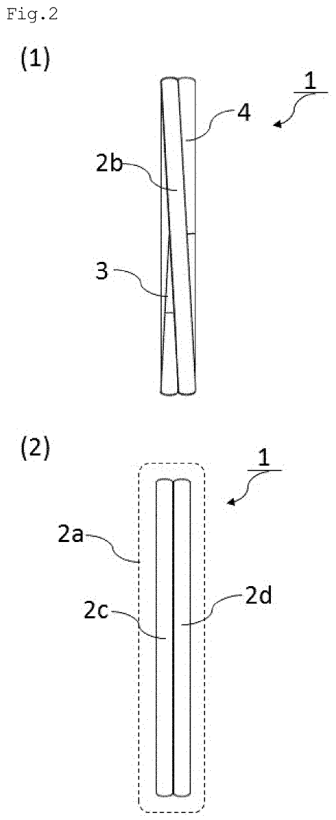

FIG. 2 is an external view of an office clip of Embodiment 1, wherein (1) is a left side view and (2) is a right side view.

As shown in FIG. 2 (2), in the sandwiching portion 2a, a front side wire 2c and a back side wire 2d come into contact with each other, and the elastic force of each wire allows the memo paper or the like to be pinched.

As shown in FIG. 1 (1), the end wire rod 4 is extended toward the center of the circle of the front side wire 2c at the sandwiching portion 2a and extended further from the substantial center. Further, as shown in FIG. 1 (2), the end wire rod 3 is extended toward the center of the circle of the back side wire 2d at the sandwiching portion 2a. As a result, the end wires (3, 4) are united to create one motif.

Further, as shown in FIG. 2 (1), the end wire 3 is provided by bending in the spiral axial direction of the ring portion 2 and toward the other end of the ring portion 2. As a result, the gripping force during use is increased. On the other hand, the end wire 4 is not bent.

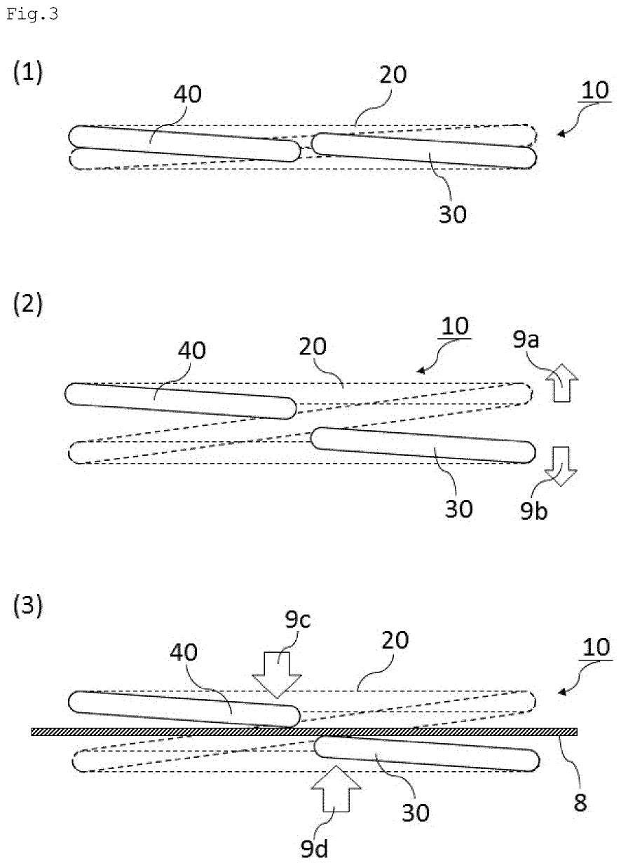

A mechanism for improving the clamping force as mentioned above will be described with reference to FIG. 3. FIG. 3 is an explanatory drawing of an office clip of the present invention, wherein (1) represents a clip in a closed state, (2) represents a clip in an open state and (3) represents a state after clipping, as plane figures of each state.

As shown in FIG. 2 (1), in the office clip 1, only one end wire 3 is provided in the spiral axial direction and towards the other end of the ring portion. However, in the office clip 10 of FIG. 3 (1), both end wires (30, 40) at the ring portion 20 are each disposed in the axial direction of the spiral and the direction of the other end of the ring portion.

Here, after opening the clip in the direction shown by the arrows (9a, 9b) in FIG. 3 (2), the memo paper 8 is sandwiched as shown in FIG. 3 (3), and the memo paper 8 can be held by the office clip 10. At that time, since the end wire (30, 40) is bent in the spiral axial direction and in the direction of the other end of the ring part 20, the elastic force is exerted in the direction indicated by the arrows (9c, 9d), and the tip portions of the end wire rods (30, 40) are firmly brought into contact with the memo paper 8 and thus the memo paper can be held.

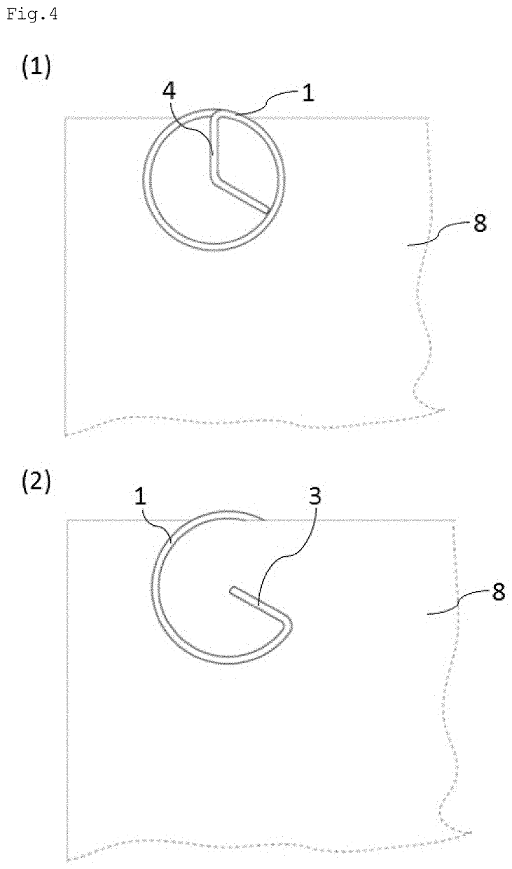

FIG. 4 is an explanatory view showing a usage state of the office clip of Embodiment 1, with (1) showing a front view and (2) showing a rear view. As shown in FIG. 4, the office clip 1 holds the memo paper 8 in between. In such a state, it is not possible to grasp all the designs provided on the office clip 1, but when the office clip 1 is removed, the design of the clip appears, and it becomes possible to entertain the viewer in the office.

### Embodiment 2

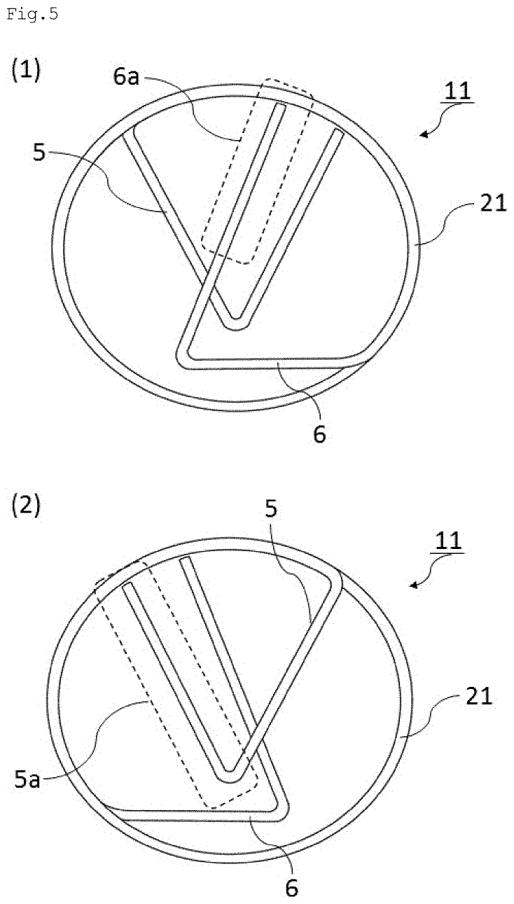

FIG. 5 is an external view of an office clip of Embodiment 2, (1) showing a front view and (2) showing a rear view. As shown in FIG. 5, the office clip 11 is formed by processing a single metal wire rod as in Embodiment 1, and includes a ring portion 21 and end wire rods (5, 6).

However, unlike Embodiment 1, the ring portion 21 of the office clip 11 has an elliptical shape, and the end wire rod 5 and the end wire rod 6 cross each other, which creates one motif by unification of end wire rods 5 and 6, resulting in a shape of high designability.

Thus, even when the end wire rods intersect with each other, the end wire rod 6 is not provided by bending the entire end wire rod 6 in the spiral axial direction and toward the other end of the ring portion, but by bending only a tip portion 6a of the wire 6 as shown in FIG. 5 (1), it is possible to enhance the clamping force. Similarly, with regard to the end wire 5 as well, it is possible to strengthen the clamping force by bending only a tip 5a as shown in FIG. 5 (2).

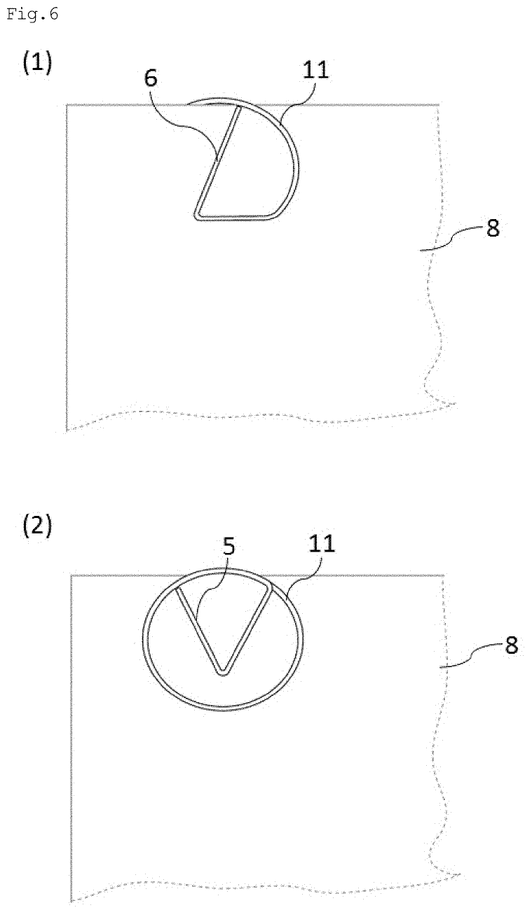

FIG. 6 is an explanatory diagram illustrating a usage state of the office clip of Embodiment 2. As shown in FIG. 6, an office clip 11 holds the memo paper 8.

In a similar manner to Embodiment 1, the design is such that the original design is expressed when the office clip 11 is removed from the memo paper 8, namely, when the office clip 11 is not in use.

### Embodiment 3

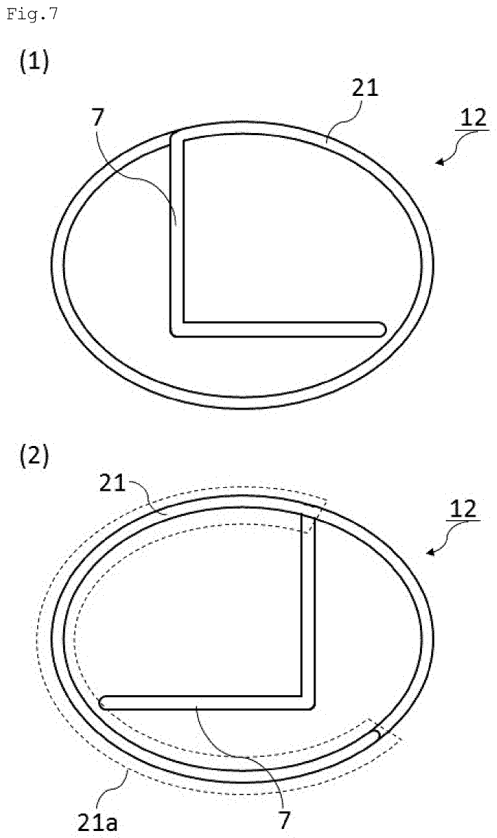

FIG. 7 is an external view of an office clip of Embodiment 3, where (1) is a front view and (2) is a rear view.

As shown in FIG. 7, unlike Embodiment 1, the office clip 12 has only one end wire rod 7 of the ring portion 21 extending toward the inside of the ring.

The spirally wound length is about one round and two-thirds of the spiral, as in Embodiment 1, and therefore, the sandwiching portion 21a occupies about two-thirds of the ring portion 21. In addition, since the end wire 7 is provided by bending in the spiral axial direction and in the direction of the other end of the ring part, a sufficient gripping force can be obtained, and thus it becomes possible to create a design by processing only one end of the ring portion.

### OTHER EMBODIMENTS

Unlike Embodiments 1 to 3, the ring portion may be configured in such a way that the front side wire and the back side wire in the sandwiching part do not come into close contact with each other and are wound at a predetermined pitch.

### INDUSTRIAL APPLICABILITY

The present invention is useful as an office clip.

### DESCRIPTION OF SYMBOLS

1, 10˜12 Office clip
2, 20, 21 Ring portion
2a, 21a Sandwiching portion
2b Non-holding portion
2c Front side wire
2d Back side wire
3˜7, 30, 40 End wire
5a, 6a Tip portion
8 Memo paper
9a˜9d Arrow

What is claimed is:

1. An office clip for pinching paper, the office clip comprising:
a wire having a ring portion and two end portions;
the ring portion configured in a spiral, the spiral having a center;
at least part of at least one of the end portions being directed inwardly toward the center of the spiral; and
a sandwiching portion configured to exert a pinching force;
the office clip further characterized in that the end portions contribute to a motif having a design-enhancing shape of the office clip.

2. The office clip of claim 1, wherein a spiral circumference of the ring portion is at least 1.67 circuits of the spiral.

3. The office clip of claim 1, wherein the ring portion includes spiral wire portions in close contact with one another.

4. The office clip of claim 1, wherein the ring portion includes spiral wire portions which are not in close contact with one another due to being configured in the spiral at a predetermined pitch.

5. The office clip of claim 1, wherein at least a respective part of both of the end portions is directed inwardly toward the center of the spiral.

6. The office clip of claim 1, wherein the motif includes a character.

7. The office clip of claim 1, wherein the motif includes a number.

8. The office clip of claim 1, wherein the motif includes a geometrical shape.

9. The office clip of claim 1, wherein the motif includes a logo mark.

10. The office clip of claim 1, wherein the motif includes a combination of at least two of the following: a character, a number, a figure.

11. The office clip of claim 1, wherein the spiral has at least one of the following shapes: an elliptical shape, a rectangular shape, a polygonal shape.

12. The office clip of claim 1, wherein the spiral has a circular shape.

13. The office clip of claim 1, wherein the ring portion has a spirally wound length which is more than one and one-half rounds of the spiral and less than two rounds of the spiral.
